(19) United States
(12) Patent Application Publication
(10) Pub. No.: US 2026/0050893 A1
(43) Pub. Date: Feb. 19, 2026

(54) PROACTIVE EQUIPMENT MAINTENANCE AND CONTROL THROUGH REMOTE EDGE MONITORING

(71) Applicant: SAUDI ARABIAN OIL COMPANY, Dhahran (SA)

(72) Inventors: Sahejad PATEL, Dhahran (SA); Siddharth MISHRA, Dhahran (SA); Hassane TRIGUI, Dhahran (SA); Raed SAMANOODI, Dhahran (SA); Ali J. ALRASHEED, Dhahran (SA); Mona ALSHAHRANI, Dhahran (SA)

(73) Assignee: SAUDI ARABIAN OIL COMPANY, Dhahran (SA)

(21) Appl. No.: 18/807,416

(22) Filed: Aug. 16, 2024

(51) Int. Cl. G06Q 10/20; G05B 23/02

(52) U.S. Cl. CPC G06Q 10/20; G05B 23/0283

(57) ABSTRACT

System and methods are disclosed relating to cloud edge based anomaly detection. In an example, an edge monitoring node can include a thermal camera to capture a thermal image of equipment that is under monitoring for an an anomaly event. The node further includes a machine learning (ML) model to process the thermal image of the equipment to detect the anomaly event. The node further includes a network interface to communicate the detected anomaly event over a network to a remote computing platform to determine one or more recommendations for proactive maintenance of the equipment.

### FIELD OF THE DISCLOSURE

This disclosure relates generally to equipment maintenance, and more particularly to cloud edge based anomaly detection.

### BACKGROUND OF THE DISCLOSURE

Companies or teams that are responsible for maintenance and reliability of equipment (known as field organizations) face various challenges, such as repeated failures of electrical systems (e.g., electric motors, switchgears, uninterruptible power supply (UPS), battery banks, circuit breakers, etc.), which leads to production failures and plant shutdowns, reliability issues that can lead to a reduction in availability of mechanical rotating equipment (e.g., pumps, compressors, turbines, fans, mixers, gear boxes, etc.), and higher maintenance efforts (e.g., for static equipment upkeep, such as heat exchangers, furnaces, boilers, valves, pipelines, etc.).

Thermography is used by field organizations, such as in an energy sector, to detect equipment abnormalities before such operating conditions lead to failures and/or unplanned shutdowns. Thermography is used for proactive maintenance for enhancing safety, reducing downtime, and lowering operational and replacement costs. In an electrical systems domain, thermography can be used for continuous monitoring and detecting anomalies in electric motors, switchgear, battery banks, panels, UPS, circuit breakers, etc. In a mechanical domain, thermography supports condition-based maintenance for pumps, compressors, blowers, and other mechanical equipment. For static types of equipment, thermography can be used for root cause analysis (RCA) and detecting defects in valves, heat exchangers, furnaces, steam traps, and other static components.

Existing thermography methodologies are either based on using baseline analysis, comparative analysis, or thermal trend analysis. Baseline analysis uses a reference baseline image of equipment (or component) under normal operating conditions for anomaly detection. Comparative analysis relies on comparing similar equipment (or components) under similar conditions to assess a condition of the equipment being monitored. For example, if similar equipment is expected to run under similar loads/conditions, any anomaly in one can indicate an issue. Thermal trend analysis is based on comparing temperature distributions in the same components or equipment over time. By tracking thermal signatures and distributions over time, a prediction can be made as to when the equipment (or component) is likely to fail.

Cloud computing is a technology that allows users to access and store data and applications on remote servers via the internet. Managed by providers like Amazon Web Services and Microsoft Azure, these services offer scalable resources such as storage, databases, and software. The benefits include cost efficiency, as users pay only for what they use, and accessibility from any location with an internet connection, enabling flexible and dynamic IT capabilities. Cloud edge computing brings data processing closer to the data source or end-user by using local devices or edge servers. This reduces latency and bandwidth usage, making it ideal for real-time applications like autonomous vehicles and internet of things (IoT) devices. By processing data locally, edge computing enhances speed and responsiveness and offers greater reliability, as it can continue functioning even if the connection to central cloud servers is disrupted.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

According to an embodiment, a system for monitoring equipment for anomaly event can include an edge monitoring node that can include a thermal camera to capture a thermal image of the equipment, an ML model to process the thermal image of the equipment and an additional thermal image of the equipment from another thermal camera that is remote to the edge monitoring node to detect the anomaly event, and a network interface to communicate the detected anomaly event over a network to a remote computing platform to determine one or more recommendations for proactive maintenance of the equipment.

According to another embodiment, a method for detecting an anomaly event of equipment using an edge monitoring node can include receiving, using the edge monitoring node, a first thermal image captured of the equipment at a first viewpoint with respect to the equipment, receiving, using the edge monitoring node, a second thermal image captured of the equipment at a second viewpoint with respect to the equipment, combining, using the edge monitoring node, the first and second thermal images provide a combined thermal image, processing, using the edge monitoring node, the combined thermal image using an ML model to detect the anomaly event, and communicating, using the edge monitoring node, the detected anomaly event to a remote computing platform to initiate maintenance of the equipment.

In a further embodiment, a system can include a first edge monitoring node that can include a first thermal camera to provide a first thermal image of equipment a first angle relative to the equipment. The system can further include a second edge monitoring node that can include a second thermal camera to provide a second thermal image of the equipment at a second angle relative to the equipment, an anomaly detection model to process the first and second thermal images to detect an anomaly event at the equipment, and a network interface to communicate the detected anomaly event over a network. The system can further include a remote computing platform to receive the communicated detected anomaly event from the network. The remote computing platform can include a recommendation engine to determine one or more recommendations for proactive maintenance of the equipment, and a report generator to generate an anomaly report that can include the one or more determined recommendations. The remote computing platform can be implemented on one or more computing nodes in a cloud computing environment, and the second edge monitoring node is implemented at an edge of the network.

### BRIEF DESCRIPTION OF THE DRAWINGS

FIG. 1 is an example of an anomaly detection system.

FIG. 2 is an example of a hardware architecture of an edge monitoring node.

FIG. 3 is an example of a single-node architecture for monitoring equipment.

FIG. 4 is an example of a multi-node architecture for monitoring equipment.

FIG. 5 is an example of a set of thermal images of a pump.

FIG. 6 is an example of a set of thermal images of a motor.

FIG. 7 is an example of a set of thermal images of a heat exchanger.

FIG. 8 is an example of a method for generating an anomaly report.

FIG. 9 is an example of a method for determining whether equipment has an anomaly event.

FIG. 10 is an example of a method for controlling equipment at an edge of a network.

FIG. 11 depicts an example computing environment that can be used to perform methods according to an aspect of the present disclosure.

FIG. 12 depicts a cloud computing environment that can be used to perform one or more actions according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments of the present disclosure relate to edge monitoring of equipment. Edge monitoring refers to anomaly data processing (e.g., monitoring and detection) locally of equipment at a facility, plant, or location. Existing thermography-based maintenance approaches are expensive due to equipment costs, operator certification, manual control, and offer limited real-time data analysis and diagnosis. Additionally, existing thermography monitoring systems struggle with limited coverage and consistency in recording data. Oil, gas, and industrial companies use various mechanical components, such as flanges, which are used to connect pipes, valves, pumps, or other equipment to form a piping system. Flanges are generally used to provide a leak-free connection. Regular physical inspection of flanges is necessary to detect any signs of wear, corrosion, or damage that could lead to leaks and potential system failures. Because of the above drawbacks of existing thermography-based maintenance approaches it is difficult to detect and respond to flange anomalies.

According to the examples herein, systems and methods are disclosed herein relating to proactive maintenance of equipment (or component of equipment) based on edge computing. In an example, an edge monitoring node is disclosed that leverages machine learning (ML) and image analysis for real-time decision-making and reporting. In some examples, the edge monitoring node can be referred to as an internet of things (IoT) device or an edge computing device. The edge monitoring node can be configured with one or more ML models that have been trained to detect and classify equipment (or components of the equipment) anomaly events in real-time at an edge. The edge monitoring node allows field organizations to make more effective maintenance decisions in contrast to existing approaches.

The edge monitoring node is configured with a hardware and/or software architecture that uses ML techniques to process thermal images such as infrared (IR) images to monitor equipment for anomalies. The term “anomaly event” (or anomaly) as used herein with respect to equipment (or asset) can include the equipment (or the asset) itself, or one or more components of the equipment (or the asset). In some examples, the edge monitoring node can be attached to steel structures around a facility using a mechanical attachment for monitoring the equipment. As disclosed herein, in some instances, a single or a multi-node system can be used with a number of edge monitoring nodes so that an asset can be monitored from various angles at a same (or substantially same) time. As such, the single or a multi-node system, as disclosed herein, allows for AI-driven data driven insights based on equipment type and allows for automatic classification, detection and reporting of equipment anomalies. The edge monitoring nodes of the present disclosure can be used to monitor any type of equipment at a facility, plant, and/or locations using IR and ML technology to provide real-time anomaly event detection.

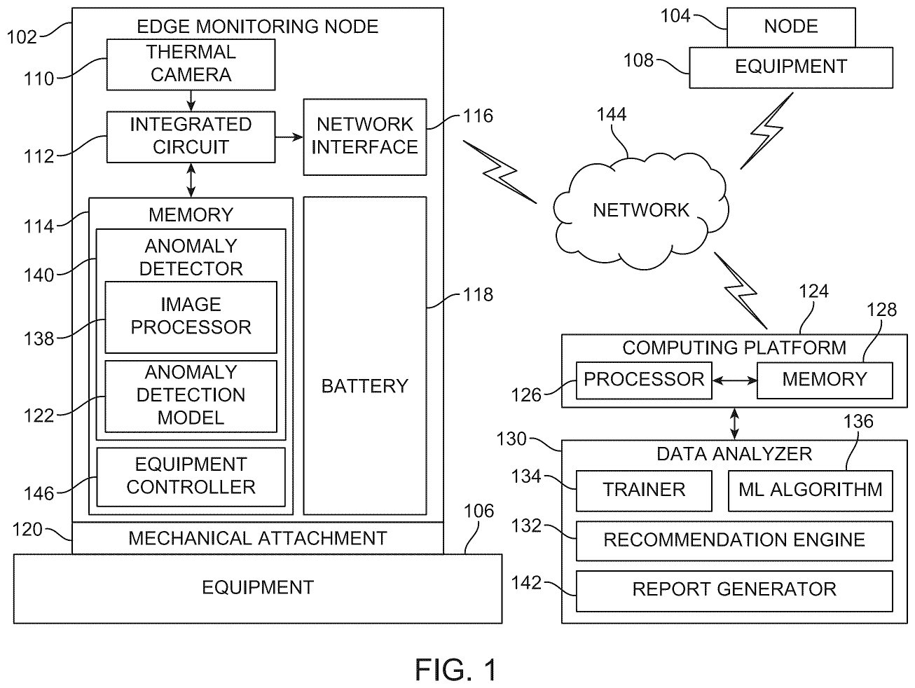

FIG. 1 is an example of an anomaly detection system 100 that includes a number of edge monitoring nodes 102-104 that can be used to monitor equipment at a location for an anomaly event. The location at which the equipment resides can include a facility, a plant, or any other location. In some examples, the system 100 is referred to as a wireless AI-driven IR monitoring system and can provide real-time analysis for proactive equipment maintenance. Thus, the system 100 can be modular, wireless and deployable at scale and configured to monitor a location (e.g., the facility) as a whole with active real-time analysis. For example, the edge monitoring node 102 can be used to monitor equipment 106 and the edge monitoring node 104 can be used to monitor equipment 108 for an anomaly event. By way of example, the anomaly event can include, but not limited to, an equipment failure, a component failure, malfunction, etc. In some examples, the edge monitoring nodes 104-106 can monitor similar or different equipment.

The edge monitoring node 102 includes a thermal camera 110, an integrated circuit 112, a memory 114, a network interface 116, and a battery 118. The battery 118 is used to provide power to components of the edge monitoring node 102, for example, as shown in FIG. 1. The thermal camera 110 can include a micro-thermal camera, such as offered by Teledyne FLIR LLC. In some examples, the thermal camera 110 includes a micro thermal camera module. The thermal camera 110 can be used to provide a thermal image of the equipment 106. The integrated circuit 112 can include a microcontroller or a system on chip (SoC). The integrated circuit 112 can be custom circuitry that can be defined for processing the thermal image of the equipment 106. The integrated circuit 112 can process the thermal image using an anomaly detector 140 for anomaly event detection (e.g., predicting whether the equipment 106 has an anomaly event). The network interface 116 can be used by the integrated circuit 112 to communicate data, such as thermal image and/or the anomaly event predicted by the anomaly detector 140 over a network 144 to a computing platform 124. In some examples, the network interface 116 can be used to allow a tablet or another portable device to connect to and communicate with the edge monitoring node 102 to retrieve anomaly event data from the edge monitoring node 102. In some examples, the edge monitoring node 102 includes a portable storage card, such as an SD card for storing the thermal image and/or the anomaly event data to allow a user to retrieve such images and data manually.

The computing platform 124 can be implemented using one or more modules, shown in block form in the drawings in the example of FIG. 1. The one or more modules can be in software or hardware form, or a combination thereof. The computing platform 124 can include any computing device, for example, a desktop computer, a server, digital cloud, a controller, a blade, a mobile phone, a tablet, a laptop, a personal digital assistant (PDA), or other types of portable (or stationary) devices. The computing platform 124 can include a processor 126 and a memory 128. By way of example, the memory 128 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 126 can be implemented, for example, as one or more processor cores. The memory 128 can store machine-readable instructions that can be retrieved and executed by the processor 126. Each of the processor 126 and the memory 128 can be implemented on a similar or a different computing platform. The computing platform 124 could be implemented in a computing cloud and thus on a cloud computing architecture. In such a situation, features of the computing platform 124 could be representative of a single instance of hardware or multiple instances of hardware executing across the multiple of instances (e.g., distributed) of hardware (e.g., computers, routers, memory, processors, or a combination thereof). Alternatively, the computing platform 124 could be implemented on a single dedicated server or workstation.

In some examples, the edge monitoring node 102, has a housing, such as disclosed herein, in which the components, as shown in FIG. 1, can be located therein. A mechanical attachment 120 can be fixed or secured to the housing to allow the edge monitoring node 102 to be attached to a structure, object, or the equipment 106. In some examples, the mechanical attachment 120 is a magnet so that the edge monitoring node 102 can be attached to a steel structure (e.g., on or near the equipment 106). For attachment to metallic surfaces, the mechanical attachment 120 can have magnetic properties to snap or adhere to a ferrous structure. The mechanical attachment 120 can include permanent magnets or switchable permanent magnets. For non-metallic surfaces, the mechanical attachment 120 could include straps, Velcro, suction-cups, or any other form of attachment. In some instances, a structure to which the edge monitoring node 102 is attached can experience vibrations, which can impact a quality of the thermal image provided by the thermal camera 110. In such examples, the edge monitoring node 102 can be stabilized using a gimbal mechanism. Software stabilization techniques commonly used in computer vision applications can be used in conjunction with hardware for improved thermal image capturing during vibration conditions at the edge monitoring node 102.

Once the edge monitoring node 102 is secured relative to the equipment 106 (or before) the edge monitoring node 102 can be operated in a monitoring state during which the edge monitoring node 102 monitors the equipment for the anomaly event. The integrated circuit 112 can access the memory 114 to retrieve an anomaly detection model 122 of the anomaly detector 140. In some examples, the system 100 is implemented according to an event-driven architecture (EDA). The EDA can be used when a timely response and/or management of the equipment 106 is needed, which allows for efficient processing of data and responding to anomaly events. Each anomaly event (e.g., a sudden temperature spike) can trigger a particular response (e.g., workflow) or alert that can lead to an action, such as shutting down the equipment 106 to prevent equipment damage. In some examples, the memory 114 can include an equipment controller 146 that can be configured to communicate a control command for adjusting an operating state or condition of the equipment 106. For example, the anomaly detection model 122 can evaluate the thermal image of the equipment 106 to determine whether an anomaly event is present or occurring at the equipment 106. The anomaly detection model 122 can output an anomaly alert, which can be provided to an equipment controller 146. The equipment controller 146 can generate the control command based on the anomaly alert. In some examples, the equipment 106 is configured for wireless communication, and the edge monitoring node 104 can communicate the control command over the network 144 to the equipment 106. An operating state or mode of the equipment 106 can be adjusted based on the control command to mitigate any potential risk (e.g., structure or health risks) posed by the equipment 106 until maintenance can be carried out on the equipment 106.

In some examples, the anomaly detection model 122 processes the thermal image to provide the anomaly data. The anomaly data can include information derived from processing one or more thermal images of the equipment 106 provided by the thermal camera 110. The anomaly data can include an identification of the anomaly event (e.g., a description or classification of a particular anomaly detected (e.g., overheating, abnormal vibration, component wear), a location of the anomaly event (e.g., location on the equipment 106 where the anomaly event was detected, for example, specified in coordinates or using a component identifier, or using an anomaly map), a severity of the anomaly event (e.g., an assessment of the severity or urgency of the anomaly, which may be quantified (e.g., a severity score) or categorized (e.g., critical, moderate, low)), a timestamp (e.g., date and time when the anomaly event was detected), historical reference, (e.g., references to historical data or similar past anomaly events detected in the same or similar equipment), and/or an environmental condition information (e.g., such as temperature, pressure, and operational load at a time the anomaly event was detected)

In some examples, the memory 128 of the computing platform 124 includes a a data analyzer 130 that includes a recommendation engine 132 that can be used to provide a maintenance plan (or action) for conducting maintenance on the equipment 106 in response to the anomaly event detected by the anomaly detection model 122. The recommendation engine 132 can receive the anomaly event data indicating that the anomaly event was detected at the equipment 106. Using the anomaly event data, the recommendation engine 132 can identify an appropriate response to the anomaly event.

The recommendation engine 132 can be implemented using ML algorithms and/or rule-based systems that analyze the anomaly event data. The recommendation engine 132 can evaluate multiple potential maintenance actions by considering historical maintenance data, a severity of the anomaly event, and/or operational context of the equipment 106. The recommendation engine 132 can utilize a decision-making framework, such as a weighted scoring system or multi-criteria decision analysis, to rank these potential actions. The recommendation engine 132 can select a most appropriate maintenance plan based on this analysis, such that the chosen plan (most) effectively addresses the anomaly event, in some instances, with minimal disruption to operations. For example, if the anomaly event data indicates a component failure, the recommendation engine 132 can evaluate options such as immediate replacement, scheduled maintenance, or temporary fixes. By considering factors like downtime costs, availability of replacement parts, and historical success rates of different actions, the recommendation engine 132 can recommend an optimal maintenance plan to rectify the anomaly event efficiently to avoid costly downtime.

Because ML processing is implemented on the edge monitoring node 102 for anomaly event detection this reduces a latency and bandwidth that is needed to transmit data over the network 144 to the computing platform 124. Infrared sensors installed on or near rotating equipment can perform initial data processing locally (at an edge/node). As such, relevant data, such as detected anomaly events are sent to the data analyzer 130 for further analysis (e.g., recommendation) or archival. Using an edge computing architecture increases an efficiency of equipment failure detection and reduces a load on a central infrastructure (e.g., the computing platform 124). In some examples, by implementing the system 100 using a combined client-server and peer-to-peer (P2P) architecture, each edge monitoring node can send data to a central server for in-depth analysis and long-term trending while also communicating directly with each other (P2P) to share local data and decisions. Such a hybrid approach enhanced a robustness of the system 100, allowing the system 100 to function even if a central server (e.g., the computing platform 124) is temporarily unavailable.

While the example of FIG. 1 illustrates the edge monitoring node 102 with a single ML model (e.g., the anomaly detection model 122), in other examples, such as when the edge monitoring node 102 is implemented as a master edge monitoring node, the edge monitoring node 102 can include two or more ML models, each having been detect unique equipment anomaly events.

For example, to provide the anomaly detection model 122, a trainer 134 can be used. The trainer 134 can be used to train an ML algorithm 136 using thermal images that contain healthy equipment and defective equipment to provide the anomaly detection model 122 that can be used at the edge monitoring node 102. In some examples, the ML algorithm 136 is trained based on thermal images of the equipment 106 from different angles, which can be provided, in some instances, by different thermal cameras. By using thermal images of the equipment 106 from different angles can be used to improve an ability of the anomaly detection model 122 to detect anomaly events. The thermal images used for the training can be collected from using actual equipment in all possible states. For instance, for pumps, thermal images can be collected in healthy, bearing misalignment or tube clogging states. Moreover, patterns for these states can also be simulated using simulation and modeling packages that depend on physical modeling, such as ANSYS, COMSOL, or Blender. Collecting training data in different scenarios increases an accuracy of the anomaly detection model 122. The scenarios that could impact a performance of an ML model can include ambient temperature, camera view angle and position relative to the object of interest, camera resolution and parameters, camera or equipment vibrational instability, various equipment designs and configurations, etc. All of these variations can be accounted for by the ML algorithm 136 such that the ML algorithm 136 can become invariant. In some examples, if the anomaly detection model 122 is to operate in rainy and/or snowy weather conditions, then an effect of these conditions on thermal images can be included in the training data for training the ML algorithm 136. In some examples, data augmentation can be used to alter the training data for training the ML algorithm 136 and introduce variations that can exist in real world, such as specific color range jittering, random occlusions which act as line of sight (LOS) obstacles, image resizing for various resolutions, blurriness for vibration scenarios, etc.

In some examples, the system 100 can include thermal cameras so thermal images of the equipment 106 can be captured from different angles (viewpoints). These images can be combined and fused to allow for comprehensive assessment, improved diagnostic accuracy, and verification of repairs according to one or more examples, as disclosed herein. For example, capturing thermal images from various angles can allow for a more thorough inspection of the equipment 106 and thus ensure that parts (or components) of the equipment 106, including those that might be hidden from one angle, are monitored for anomaly events. Furthermore, by evaluating multiple thermal images enhances an accuracy of diagnostics by providing a 3D thermal profile, which can be used to better understand a heat distribution and underlying issues of the equipment 106. After maintenance or repairs, additional thermal images can be used to verify that the anomaly event has been properly addressed and that the equipment 106 is operating within or under normal thermal conditions from all angles. In some examples, the edge monitoring node 102 can be configured with a color camera (not shown in FIG. 1), such as a red-green-blue (RGB) RGB camera, to provide a color image of the equipment 106. The color image can be processed to provide an additional layer of maintenance monitoring and for anomaly event detection, such as overheating, misalignment, and lubrication failures, as an example. For instance, the anomaly detection model 122 can be trained (e.g., based on the training data, which can include color images of equipment operating under normal and non-normal conditions) to process the color image provided by the color camera to detect the anomaly event. Thus, the anomaly event, in some instances, can be detected at the edge monitoring node 102 at different visual information layers (e.g., based on RGB and/or thermal images)). Because the edge monitoring node 102 uses two different imaging cameras increases a likelihood that the edge monitoring node 102 detects the anomaly event at the equipment 106.

In some examples, the equipment 106 is rotating equipment, and image alignment is needed due to a dynamic nature of such machinery. For example, the memory 114 can include an image synchronizer (not shown in FIG. 1). The integrated circuit 112 can use the image synchronizer to synchronize the thermal camera 110 and the RGB camera to capture respective images simultaneously (or about simultaneously). The RGB and thermal cameras can capture images simultaneously to ensure that a thermal image corresponds to a visible condition of the equipment (e.g., the color image).

In some examples, the edge monitoring node 102 includes a high-pass filter, which can be implemented as hardware, software, and/or a combination thereof. The high-pass filter can be used for detecting surface defects. The color image from the color camera can be processed using the high-pass filter to emphasize edges and texture to provide an enhanced color image. The high-pass filter can accentuate fine details and edges in the color image, such as cracks, scratches, or other surface irregularities on the equipment 106. In some examples, the color image and the thermal image are provided to the anomaly detection model 122, which can be trained for image processing.

For example, the enhanced color image can be overlaid onto the thermal image by the anomaly detection model 122 to provide a fused image. The fused image can be processed by the anomaly detection model 122 to highlight thermal anomalies, for example, caused by friction, misalignment, or overheating. The process of overlaying the enhanced color image onto the thermal image allows for more accurate thermal anomaly detection. When detailed visual information (e.g., the enhanced color image) is superimposed onto the thermal image, the result provides a comprehensive view that combines both visual and thermal data. By highlighting locations and shapes of surface defects in the context of the thermal image using the enhanced color image, the anomaly detection model 122 can correlate visible conditions with underlying thermal anomalies. For instance, an area with intensified heat in the thermal image can coincide with a visible crack or misalignment in the enhanced color image, indicating that friction or improper alignment is causing excessive heat, and the anomaly detection model 122 can provide the anomaly alert to notify the user of such a condition based on the fused image. Thus, the fused image allows for identifying particular issues like overheating, friction hotspots, or misalignment, which might not be as apparent when viewing the thermal or color images in isolation. In some instances, for diagnosis, the fused image can undergo further processing to enhance critical features, such as rotating equipment. Contrast enhancement can make minor differences in heat signatures more noticeable, indicating potential failure areas. Additionally, edge enhancement can better define component boundaries and highlight regions with abnormal wear or deformation.

For example, the anomaly detector 140 can include an image processor 138, which can be used for identifying an appropriate ML model for processing thermal images, for example, in instances in which the edge monitoring node 102 is implemented as a master edge monitoring node, such as disclosed herein. The image processor 138 can identify an ML model from a number of ML models in the memory 114 for processing the thermal image. The image processor 138 can select one of the ML models from the memory 114 for processing the thermal image, which can correspond to the anomaly detection model 122, in some instances. The image processor 138 can receive the thermal and/or color image. The image processor 138 can detect an object in the thermal image representative of the equipment 106, for example, using an object detection algorithm. The object detection algorithm can include, but not limited to, You Only Look Once (YOLO), Single Shot Multibox Detector (SSD), and a region-based convolution neural network (R-CNN). The detected object can be referred to as an equipment object.

In some examples, the image processor 138 can use an object extraction algorithm to extract the equipment object from the thermal image to create a new image, often with a background removed. Thus, an output of the object extraction algorithm can result in a separate image or mask where the equipment object is isolated from a remaining portion of the thermal image. The object extraction algorithm can include image segmentation techniques, such as a mask R-CNN, a semantic segmentation algorithm, such as U-Net, or techniques such as image matting and background subtraction. Thus, the object extraction algorithm can segment the equipment object from the thermal image to provide a segmented thermal image.

After initial object segmentation, the image processor 138 can implement a fine-grained segmentation of the thermal image (the extracted equipment object). For example, the image processor 138 can use a fine-grained segmentation model, such as a mask R-CNN that has been trained on a fine-grained training dataset. For example, to train the fine-grained segmentation model, the fine-grained training dataset can include labels for different parts of the equipment object (e.g., bearings, tubing, etc.). The fine-grained segmentation model can be trained on the fine-grained training dataset to learn to segment the equipment object into its constituent parts. The fine-grained segmentation model can process the equipment object to segment each part of the segmented object to provide a separate mask or image. The segmented parts (referred to as a segmented thermal image part) can be fed into the anomaly detection model 122 for detailed analysis and thus anomaly detection. Thus, after the initial object segmentation, the fine-grained segmentation model can be used to segment the segmented thermal image to provide one or more segmented thermal image parts.

In some examples, camera parameters of the thermal camera 110 can be optimized in a calibration step by the image processor 138 to enhance a performance of the anomaly detection model 122. One or more camera parameters of the thermal camera 110, such as emissivity parameter of the thermal camera 110 can be tuned (e.g., adjusted) by the image processor 138, which can lead to an improvement in an anomaly detection accuracy at the anomaly detection model 122. The emissivity parameter of the thermal camera 110 can be adjusted to account for varying material properties of the equipment 106 that are being monitored to ensure accurate thermal data is provided to the anomaly detection model 122.

In some examples, the image processor 138 can determine a type of equipment that is detected in the thermal image based on the equipment object. The image processor 138 can select the anomaly detection model 122 from the ML models in the memory 114 based on the determined equipment type. Detection of anomalies by the anomaly detection model 122 can be implemented using model classification based on the segmented thermal image or the segmented thermal image part, where a number of classes indicates a number of anomaly and healthy cases. One common type of anomaly detection is hotspot/cold-spot detection. For example, in heat exchangers, cold spots indicate an inefficient heat exchanging process, suggesting that maintenance may be needed to maximize an efficiency of the heat exchange process. The anomaly detection model 122 can be trained on various scenarios of hot/cold spots as well as normal heatmaps of the equipment 106 so that the anomaly detection model 122 can detect these anomalies.

In some examples, the anomaly detection model 122 can determine a severity of the anomaly event using a regression model based on the segmented thermal image or the segmented thermal image part. For example, in the case of bearing misalignment, the anomaly detection model 122 can predict a bearing angle to indicate an extent of misalignment. The regression model can predict trends over time, such as forecasting an expected degree of misalignment if a pump motor load is maintained or changed over time. Anomaly classification and regression can be applied to all types of failures in different industrial equipment based on a type of anomaly detection model that is selected by the image processor 138.

In some examples, the anomaly detector 140 can receive multiple thermal images of the equipment 106 from different viewpoints (angles), which can be referred to as multi-view thermal images. Each thermal image of the multi-view thermal images can be processed to provide the segmented thermal image or segmented thermal image part, which can be associated with one of the different viewpoints. Each segmented thermal image or segmented thermal image part can be processed by the anomaly detection model 122 to compute a vote regarding a presence or absence of the anomaly event at the equipment 106. For example, if thermal images of a heat exchanger are taken from five different angles, each thermal image can be analyzed separately by the anomaly detection model 122, and each analysis can result in a vote: either indicating the anomaly event or no anomaly event. Using each vote, provided based on a respective view of the equipment 106, can be processed by the anomaly detection model 122 to provide a final indication (e.g., prediction) of whether the anomaly event is present at equipment 106. Thus, the anomaly detection model 122 can make a final decision based on a majority vote. By way of example, if three out of five thermal images indicate the anomaly event is present at the equipment 106, then the anomaly detection model 122 can output the anomaly event data indicating that the equipment 106 has the anomaly event.

In some examples, the multi-view thermal images of the equipment 106 can be concatenated by the anomaly detector 140 to form a single multi-channel thermal image, where each channel corresponds to one of the different viewpoints of the equipment 106. The single multi-channel thermal image can be processed by the anomaly detection model 122 for anomaly detection. The single multi-channel thermal image can be referred to as a concatenated thermal image. Thus, by analyzing combined information from all the different viewpoints, the anomaly detection model 122 can detect the anomaly event (e.g., cold spots) more accurately when compared to individual images analysis. In examples in which multi-view thermal images or video are used, the anomaly detection model 122 can be implemented as a 3D CNN.

In some examples, each thermal image (segmented thermal image or segmented thermal image part) associated with a respective viewpoint of the different viewpoints can be processed by the anomaly detection model 122 to produce feature maps. In some examples, the anomaly detection model 122 includes a CNN for feature extraction. The feature maps can represent various characteristics of the thermal images, such as temperature variations, potential hot spots, or cold spots, as an example. The anomaly detector 140 can apply an attention algorithm to the feature maps to weight a respective feature importance. The attention algorithm can assign different weights to the feature maps from each viewpoint based on a relevance of a given feature to a detection task. For example, if one viewpoint of the equipment 106 shows a clearer indication of a cold spot, the feature maps from that viewpoint can be given higher weights. The anomaly detector 140 can aggregate the weighted features from all views to form a comprehensive representation. This can be done using techniques such as weighted summation, concatenation, or a more complex fusion method.

The aggregation process results in a unified feature map (or tensor) that combines relevant information (e.g., temperature variations, anomaly indicators, spatial relationships, temporal changes, depth information, etc.) from all the individual viewpoints. The unified feature map thus summarizes a condition of the equipment 106 by highlighting most significant features identified from different angles (view points). For example, the unified feature map can indicate a detected cold spot. In some examples, the anomaly detection model 122 includes a detection model to process the unified feature map to identify and locate the cold spot. The depth model can also estimate a depth of the cold spot if depth estimation is part of the training and available. In some examples, the unified feature map includes spatial and depth information if the detection model has been trained to estimate depth from multi-view images and thus the anomaly detection model 122 can determine a location of the anomaly on the equipment 106.

In some examples, the anomaly detection model 122 is an unsupervised ML model that can be used for unsupervised change detection. Unsupervised change detection can include using unsupervised learning techniques to identify changes in statistical properties of a sequence or stream of images. Unlike supervised learning, which uses labeled data to train the ML algorithm 136, unsupervised learning does not rely on predefined labels or known patterns for training. Instead, unsupervised learning detects deviations from a baseline (normal) by analyzing an inherent structure and patterns within data. For example, the ML algorithm 136 can be trained on a set of thermal images of the equipment 106 (or similar or same equipment) that represent normal operation conditions of the equipment 106. The set of thermal images form a baseline or reference for what is considered “normal.” The ML algorithm 136 during training can group similar thermal images of the set of thermal images into clusters based on corresponding features to provide the anomaly detection model 122. An anomaly can be detected by the anomaly detection model 122 when new thermal images do not fit well into any of the existing clusters representing normal conditions.

As new thermal images are continuously captured of the equipment 106 by the thermal camera 110, the anomaly detection model 122 can compare these incoming thermal images to baseline thermal images to detect a change. The change can include variations in temperature patterns, an appearance of new hot or cold spots, or other anomalies that differ from normal operating conditions. When a change is detected, the change indicates a potential anomaly in the equipment 106.

The anomaly detection model 122 can detect a change in data distribution between a new thermal image and a baseline thermal image. The monitoring can include using statistical analysis to detect shifts in temperature patterns or other relevant features. A shift in statistical properties between the thermal images can be indicative of the anomaly event. For example, if a temperature distribution in a new thermal image significantly deviates from a baseline distribution, this change could be indicative of the anomaly event. The anomaly detection model 122 can use a threshold to determine whether the detected shift is sufficient to be considered as indicative of the anomaly event. If the change in data distribution is greater than or equal to threshold, this is indicative of the anomaly event.

In some examples, the anomaly detector 140 can use gradient-weighted class activation mapping (Grad-CAM) to generate a heatmap that highlights a region of interest in the thermal image corresponding to one or more pixels that had a greatest influence on a final output of the anomaly detection model 122. For example, if the anomaly detection model 122 is based on a CNN, the thermal image can be fed to the CNN, which processes the thermal image and computes class scores indicating a presence of the anomaly. The score corresponding to the detected anomaly event can be selected. The gradients of this score with respect to feature maps of the CNN's last convolutional layer can then be calculated. These gradients can indicate a sensitivity of a class score to changes in the feature maps. The computed gradients can be averaged globally to determine importance weights for each feature map of the feature maps. These weights can indicate a significance of each feature map in detecting a specific anomaly. The feature maps can be multiplied by corresponding respective importance weights and combined to produce a coarse localization map (a heatmap). The coarse localization map can be passed through a ReLU activation function to highlight positive contributions. The heatmap emphasizes one or more regions of interest in the thermal image that are crucial for detecting the anomaly. The heatmap can be upsampled to match dimensions of the original thermal image. The upsampled heatmap can be overlaid on the thermal image to provide an anomaly localization map to highlight the one or more regions the thermal image that significantly influenced a decision process of the CNN (the anomaly detection model 122), which correspond to one or more areas of the equipment 106 where the anomaly event can be located.

In some examples, the data analyzer 130 can include a report generator 142 to generate an anomaly report, which can be rendered on an output device, such as disclosed herein. The report generator 142 can use the anomaly event data for generation of the anomaly report, which can be provided by the edge monitoring node 102 over the network 144 to the computing platform 124. In some examples, the report generator 142 can provide the anomaly report based on one or more recommendations generated by the recommendation engine 132 according to one or more examples, as disclosed herein. For example, the report generator 142 can use a large language model (LLM) to generate the anomaly report. Generative AI can be used for automated report generation as well as prompt-based reporting on-demand, and thus streamline a reporting process and provide detailed information, including the one or more recommendations, for the anomaly event at the equipment 106.

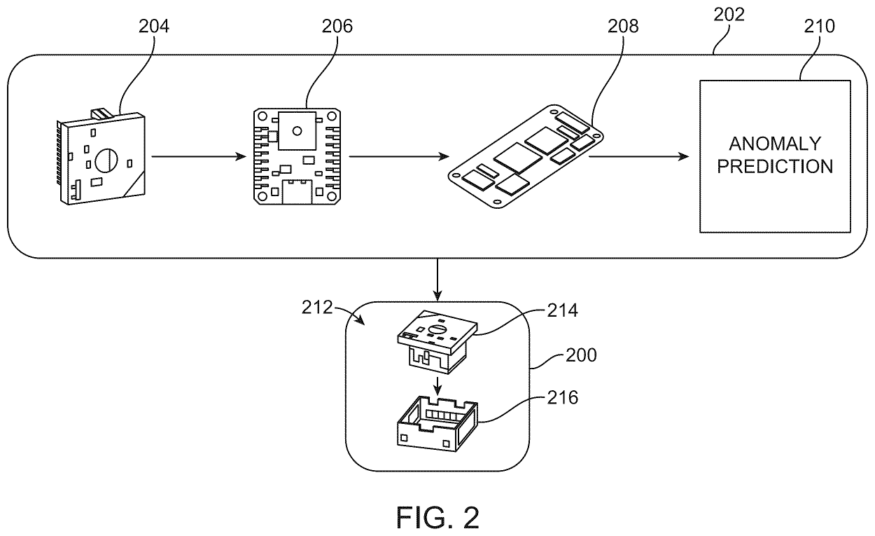

FIG. 2 is an example of a hardware architecture 200 of an edge monitoring node, such as the edge monitoring node 102 or 104, as shown in FIG. 1. Thus, reference can be made to one or more examples of FIG. 1 in the example of FIG. 2. The hardware architecture 200 includes internal components 202, such as a micro-thermal camera module 204, a thermal image pre-processing component 206, and an integrated circuit 208, which can provide an anomaly prediction 210 indicating that an anomaly event has been detected at an asset (e.g., the equipment 106, as shown in FIG. 1). The thermal image pre-processing component 206 and the micro-thermal camera module 204, in some instances, can be an IR camera, and thus correspond to an IR camera. In some examples, the IR camera is the thermal camera 110, as shown in FIG. 1. The edge monitoring node can have a housing 212 that can be formed from a first housing portion 214 and a second housing portion 216. The internal components 202 can be secured to a first face of the first housing portion 214, as shown in FIG. 2 opposite a first face of the second housing portion 216. The mechanical attachment 120, as shown in FIG. 1, can be located and/or secured on a second face of the second housing portion 216, which is opposite the first face of the second housing portion 216. In some examples, the internal components 202 can include an RGB camera to provide RGB or color images.

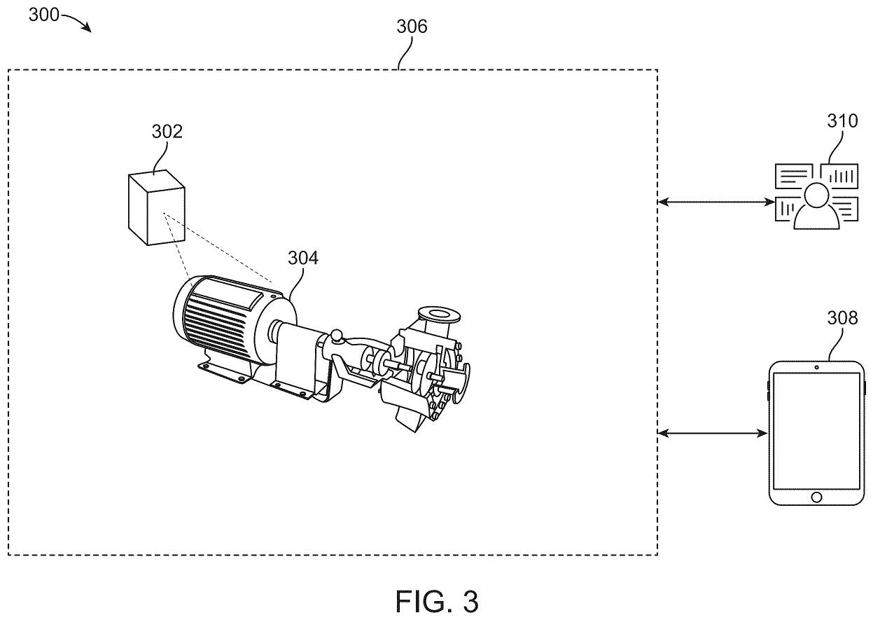

FIG. 3 is an example of a single-node architecture 300 in which a single edge monitoring node 302 is used for monitoring equipment 304 at a facility 306 for an anomaly event. In some examples, the edge monitoring node 302 is the edge monitoring node 102, as shown in FIG. 1. Thus, reference can be made to one or more examples of FIGS. 1-2 in the example of FIG. 3. The edge monitoring node 302 can capture a thermal image of the equipment 304, which in some instances can correspond to the equipment 106, as shown in FIG. 1) during operation, and process the captured thermal image using ML techniques, as disclosed herein, to predict (detect) whether the anomaly event is occurring or present at the equipment 304. In some examples, the edge monitoring node 302 can communicate with a tablet 308 that can be used by a user to view analysis and/or data from the edge monitoring node 302, such as thermal images, or anomaly event data, such as disclosed herein. In some examples, the edge monitoring node 302 can communicate data (e.g., the thermal images, the anomaly event data, and/or other types of data) to the computing platform 124, which can be configured to generate a graphical user interface (GUI) 310 for the user to visualize the communicated data (or a subset of that data).

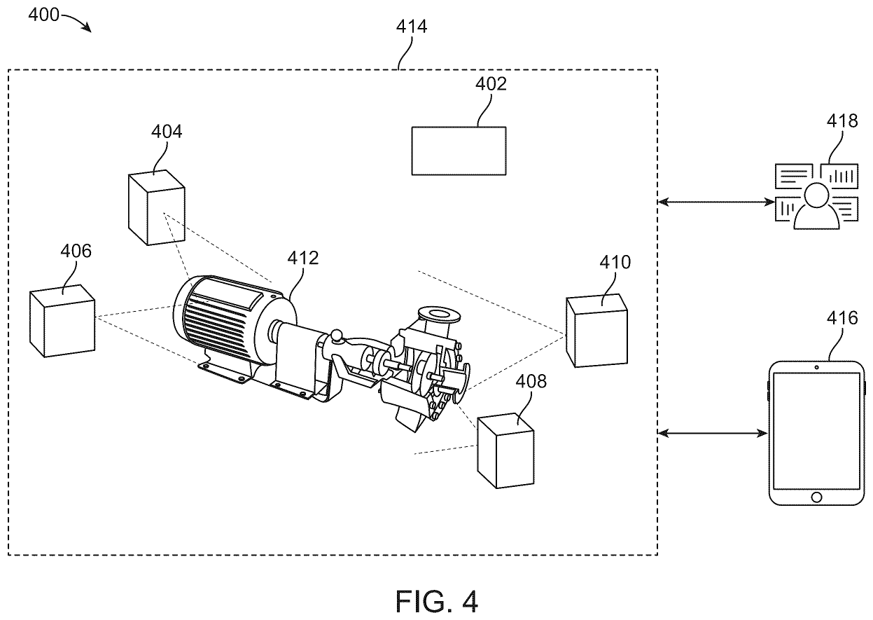

FIG. 4 is an example of a multi-node architecture 400 in which a plurality of edge monitoring nodes 402-410 are used to monitor equipment 412 at a facility 414 for an anomaly event. One of the edge monitoring nodes, such as the edge monitoring node 402 can be designated as a master edge monitoring node. The master edge monitoring node can be configured with the components of the edge monitoring node 102, as shown in FIG. 1. Thus, reference can be made to one or more examples of FIGS. 1-2 in the example of FIG. 4. Each of the remaining edge monitoring nodes 404-410 can be configured with the components of the edge monitoring node 102, as well; in some instances without ML technology, such as the anomaly detection model 122, as shown in FIG. 1. The edge monitoring nodes 404-410 can be referred to as slave edge monitoring nodes and communicate with the master edge monitoring node 402, such as using a network (e.g., the network 144, as shown in FIG. 1). The slave edge monitoring nodes can monitor different components of the equipment 412, as shown in FIG. 1. For example, the edge monitoring node 408 can monitor a suction portion of the equipment 412. Each of the slave edge monitoring nodes can provide thermal images of a respective component of the equipment 412, which in some instances, can correspond to the equipment 106, as shown in FIG. 1. In some instances, the slave edge monitoring nodes can provide the thermal images to the master edge monitoring node, which can use ML technology, such as the anomaly detection model 122 to determine whether the equipment 412 is experiencing an anomaly event according to one or more examples, as disclosed herein. Thus, in some instances, the master edge monitoring node can include a number of anomaly detection models that can be trained to detect anomalies for different components of the equipment 412. In some examples, the master edge monitoring node can communicate with a tablet 416 that can be used by a user to view analysis and/or data from master edge monitoring node, such as thermal images, or the anomaly event data, as disclosed herein. In some examples, the master edge monitoring node can communicate data (e.g., the Thermal images, the predicted anomalies, and/or other types of data) to the computing platform 124, which can be configured to generate a GUI 418 for the user to visualize the communicated data (or a subset of that data). Accordingly, the multi-node architecture 400 allows for monitoring an asset (the equipment 412) from various angles (viewpoints). The master edge monitoring node can be located nearby to collect the data from the slave edge monitoring nodes for analysis, and either send the data to the tablet 416 or a control room, or store the data at an edge (e.g., on an SD card of the master edge monitoring node).

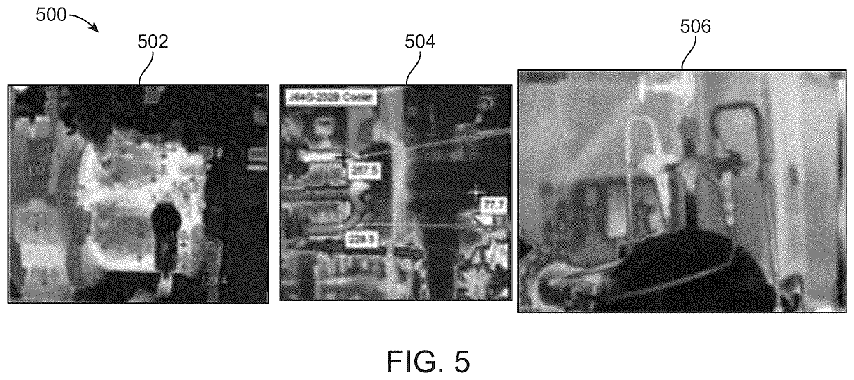

FIG. 5 is an example of a set of thermal images 500, including a first thermal image 502, a second thermal image 504, and a third thermal image 506 that can be provided by a thermal camera (e.g., the thermal camera 110, as shown in FIG. 1) at an edge monitoring node (e.g., the edge monitoring node 102, as shown in FIG. 1) of a pump (e.g., the equipment 106, as shown in FIG. 1). Thus, reference can be made to one or more examples of FIGS. 1-4 in the example of FIG. 5. Given that a limited number of critical pumps can be equipped with vibration monitoring systems, approximately 60% of pump failures can be attributed to bearing malfunctions caused by excessive vibration. Potential root causes for these vibrations can include insufficient lubrication, misalignment, and process disturbances. Typically, bearing failure is accompanied by a noticeable rise in temperature. Detecting any abnormal temperature increase by the edge monitoring node, as disclosed herein, can prompt preemptive action, thereby preventing higher maintenance costs and production losses. The first thermal image 502 is of a bearing housing of the pump that can be provided by a first edge monitoring node, the second thermal image 504 is of a sealing of the pump that can be provided by a second edge monitoring node, and the third thermal image 506 is of a plugged flushing line of the pump. According to one or more examples herein, ML technology, as disclosed herein, can be used to process the first, second, and third thermal images 502-506 to monitor the pump for an anomaly, such as bearing housing failure, sealing failure, or flushing line failure.

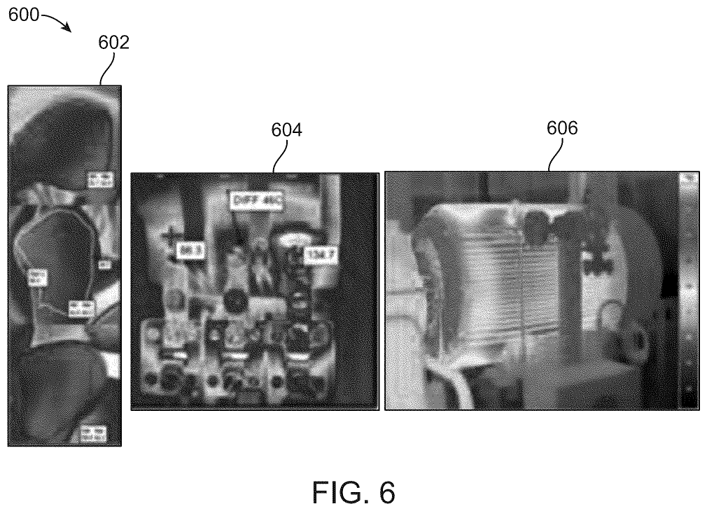

FIG. 6 is another example of a set of thermal images 600, including a first thermal image 602, a second thermal image 604, and a third thermal image 606 that can be provided by a thermal camera (e.g., the thermal camera 110, as shown in FIG. 1) of an edge monitoring node (e.g., the edge monitoring node 102, as shown in FIG. 1) of a motor (e.g., the equipment 106, as shown in FIG. 1). Thus, reference can be made to one or more examples of FIGS. 1-4 in the example of FIG. 6. The reliability of electrical motors is needed for continuous operation of facilities. Numerous motor failures are reported annually in each operating facility, often due to issues such as winding defects and bearing conditions. Monitoring the temperature of these components according to the examples herein within electrical motors can assist plant personnel in identifying potential failure zones. Thus, the proactive approach of the present disclosure can mitigate future reliability issues and prevent untimely motor failures. The first thermal image 602 is of a subset of thermal images of line and motor leads of the motor. The second thermal image 604 is a thermal image of a motor starter of the motor. The third thermal image 606 is a thermal image of a bearing of the motor. According to one or more examples herein, ML technology, as disclosed herein, can be used to process the first, second, and third thermal images 602-604 to monitor the motor for an anomaly, such as motor lead failure, starter failure, and bearing failure.

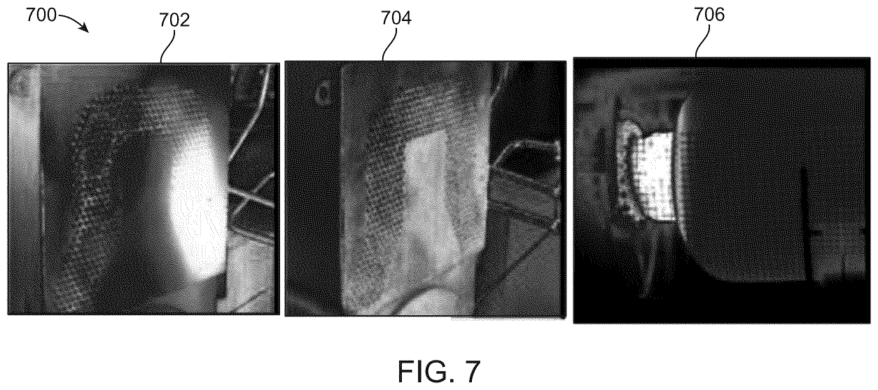

FIG. 7 is yet a further example of a set of thermal images 700, including a first thermal image 702, a second thermal image 704, and a third thermal image 706 that can be provided by a thermal camera (e.g., the thermal camera 110, as shown in FIG. 1) of an edge monitoring node (e.g., the edge monitoring node 102, as shown in FIG. 1) of a heat exchanger (e.g., the equipment 106, as shown in FIG. 1). Thus, reference can be made to one or more examples of FIGS. 1-4 in the example of FIG. 7. Heat exchangers can experience fouling. Fouling refers to the formation of unwanted material deposits on heat transfer surfaces during process heating and cooling. Fouling results in a decrease in heat exchange efficiency, which can cause interruptions in plant operations. The first thermal image 702 is a thermal image of a cooler tubes of the heat exchanger that have been clogged. The second thermal image 704 is a thermal image of the cooler tubes that are clean. The third thermal image 706 is a thermal image of an exchanger refractory. According to one or more examples herein, ML technology, as disclosed herein, can be used to process the first, second, and third thermal images 602-604 to monitor the heat exchange for an anomaly, such cooler tubes being clogged.

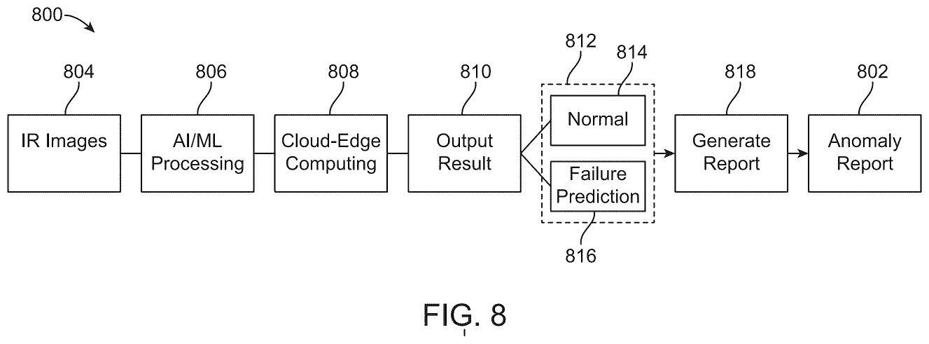

In view of the foregoing structural and functional features described above, example methods will be better appreciated with reference to FIGS. 8-10. While, for purposes of simplicity of explanation, the example method of FIGS. 8-10 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the method.

FIG. 8 is an example of a method 800 for generating an anomaly report 802. The method 800 can be implemented by the system 100, as shown in FIG. 1. Thus, reference can be made to one or more examples of FIGS. 1-7 in the example of FIG. 8. The method 800 can begin at 804 with receiving or inputting one or more thermal images (e.g., from the thermal camera 110, as shown in FIG. 1) of equipment (e.g., the equipment 106, as shown in FIG. 1). At 806, providing the one or more thermal images to an ML model (e.g., the anomaly detection model 122, as shown in FIG. 1), which is implemented at an edge monitoring node (e.g., the edge monitoring node 102, as shown in FIG. 1), and trained to detect one or more different anomaly events at the equipment. At 808, processing using the ML model the one or more thermal images. Because the one or more thermal images are processed using the ML model at the edge monitoring node this can be referred to cloud-edge computing. At 810, the ML model can output a result 812. In some instances in which the equipment is operating normally, the result 812 is a normal result 814, while, in other instances, in which the equipment has the anomaly event, the result 812 is an anomaly detected result 816 (referred to as a “Failure Prediction” in FIG. 8). The anomaly detected result 816 can be communicated as anomaly event data, or as part of the anomaly event data to a computing platform for anomaly report generation. At 818, the anomaly report 802 can be generated (e.g., by the report generator 142, as shown in FIG. 1) based on the anomaly event data.

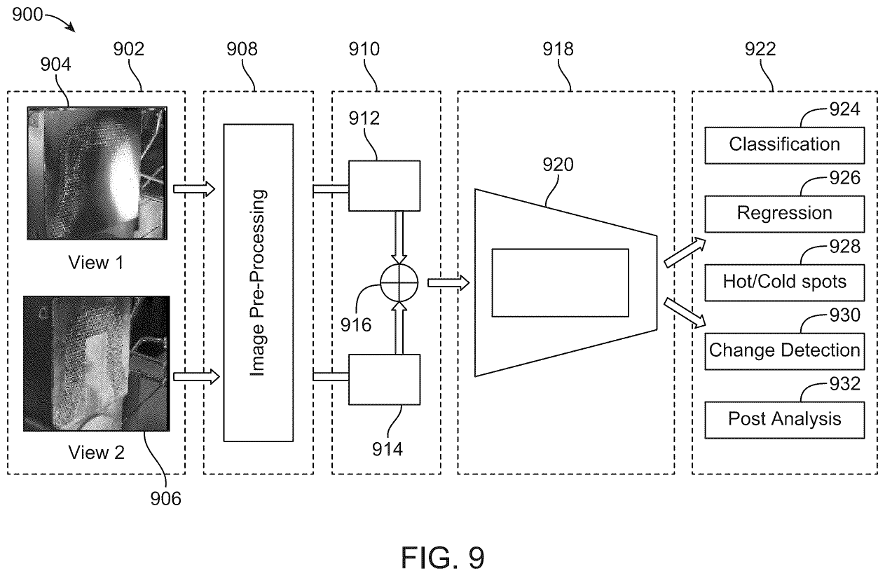

FIG. 9 is an example of a method 900 for determining whether equipment (e.g., the equipment 106, as shown in FIG. 1) has an anomaly event. The method 900 can be implemented by the edge monitoring node 102, as shown in FIG. 1. Thus, reference can be made to one or more examples of FIGS. 1-7 in the example of FIG. 9. The method 900 can begin at 902 with receiving a first thermal image 904 captured of the equipment at a first viewpoint (referred to as “View 1” in FIG. 9″) with respect to the equipment, and a second thermal image 902 captured of the equipment at a second viewpoint (referred to as “View 2” in FIG. 9″) with respect to the equipment. At 908, the first and second thermal images can be pre-processed (referred to as “Image Pre-Processing” in FIG. 9). The pre-processing can include normalization, noise reduction, contrast enhancement, image resizing, data augmentation, etc.

At 910, the first and second thermal images can be processed to provide a concatenated thermal image. For example, a first segmentation algorithm 912 can be used to segment the first thermal image to provide a first segmented thermal image, and a second segmentation algorithm 914 can be used to segment the second thermal image to provide a second segmented thermal image. The first and second segmented thermal images can be concatenated at 916 to provide the concatenated thermal image.

At 918, providing the concatenated thermal image to an anomaly detector, such as the anomaly detector 140, as shown in FIG. 1. For example, the concatenated thermal image can be provided to an anomaly detection model 920, which can correspond to the anomaly detection model 122, as shown in FIG. 1, for anomaly detection. At 922, the concatenated thermal image can be processed using the anomaly detection model 920 to determine whether the equipment has the anomaly event (e.g., the anomaly event data can indicate a presence or absence of the anomaly event at the equipment. In some examples, the anomaly detection model 122 uses a classification technique 924 to determine a type of anomaly event at the equipment, regression technique 926 to determine a severity of the anomaly event, a feature map technique 928 to identify hot and/or cold spots on the equipment, a change detection technique 930 to detect the anomaly event, and/or a post analysis technique 932, such as disclosed herein (e.g., anomaly report generation).

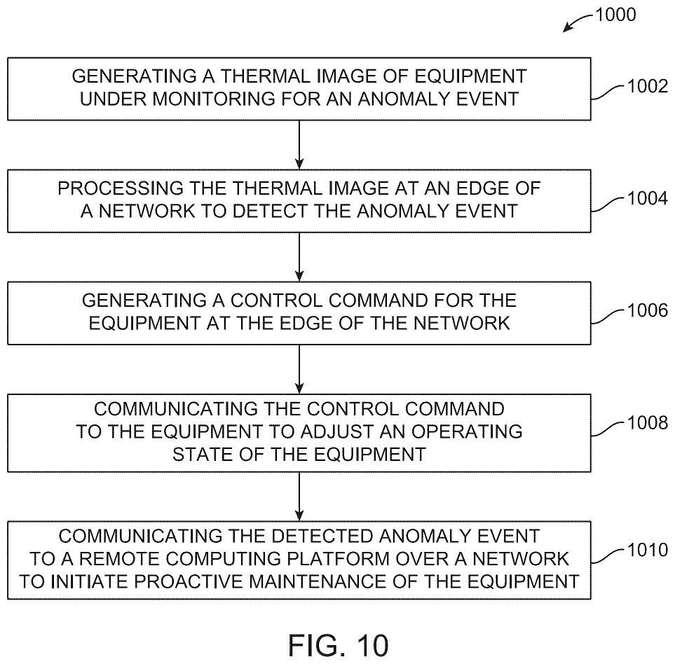

FIG. 10 is an example of a method 1000 for controlling equipment (e.g., the equipment 106, as shown in FIG. 1) using an edge monitoring node, such as the edge monitoring node 102, as shown in FIG. 1. Thus, reference can be made to one or more examples of FIGS. 1-7 in the example of FIG. 10. The method 1000 can begin at 1002 with generating a thermal image of equipment (e.g., using the thermal camera 110, as shown in FIG. 1) that is being monitored for an anomaly event. At 1004, processing, at the edge monitoring node, the thermal image using an anomaly detection model (e.g., the anomaly detection model 122, as shown in FIG. 1) that has been trained to detect the anomaly event at the equipment. Thus, at 10004, the thermal image is processed at an edge of the network. At 1006, generating (e.g., using the equipment controller 146, as shown in FIG. 1) a control command for the equipment, and thus at the edge of the network. At 1008, communicating the control command to the equipment to adjust an operating state of the equipment to reduce a risk of damage of the equipment or loss of human life. At 1110, communicating the detected anomaly event to a remote computing platform (e.g., the computing platform 124, as shown in FIG. 1) over a network to initiate proactive maintenance of the equipment. Because the anomaly detection model is used at the edge of the network (at the edge monitoring node) to detect the anomaly event, no anomaly detection model or ML is needed to be used at the remote computing platform, which reduces a bandwidth needed to communicate data from the edge monitoring node to the remote computing platform.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

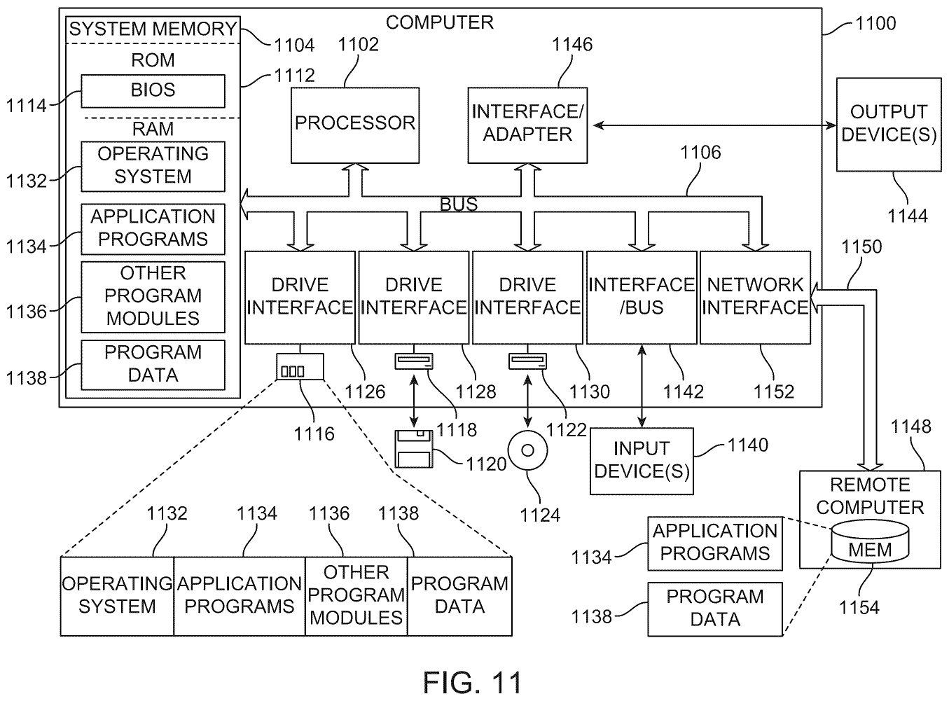

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 11. Thus, reference can be made to one or more examples of FIGS. 1-10 in the example of FIG. 11.

In this regard, FIG. 11 illustrates one example of a computer system 1100 that can be employed to execute one or more embodiments of the present disclosure. Computer system 1100 can be implemented on one or more general purpose networked computer systems, embedded computer systems, routers, switches, server devices, client devices, various intermediate devices/nodes or standalone computer systems. Additionally, computer system 1100 can be implemented on various mobile clients such as, for example, a personal digital assistant (PDA), laptop computer, pager, and the like, provided it includes sufficient processing capabilities.

Computer system 1100 includes processing unit 1102, system memory 1104, and system bus 1106 that couples various system components, including the system memory 1104, to processing unit 1102. Dual microprocessors and other multi-processor architectures also can be used as processing unit 1102. System bus 1106 may be any of several types of bus structure including a memory bus or memory controller, a peripheral bus, and a local bus using any of a variety of bus architectures. System memory 1104 includes read only memory (ROM) 1110 and random access memory (RAM) 1112. A basic input/output system (BIOS) 1114 can reside in ROM 1112 containing the basic routines that help to transfer information among elements within computer system 1100.

Computer system 1100 can include a hard disk drive 1116, magnetic disk drive 1118, e.g., to read from or write to removable disk 1120, and an optical disk drive 1122, e.g., for reading CD-ROM disk 1124 or to read from or write to other optical media. Hard disk drive 1116, magnetic disk drive 1118, and optical disk drive 1122 are connected to system bus 1106 by a hard disk drive interface 1126, a magnetic disk drive interface 1128, and an optical drive interface 1130, respectively. The drives and associated computer-readable media provide nonvolatile storage of data, data structures, and computer-executable instructions for computer system 1100. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and disclosed herein. A number of program modules may be stored in drives and RAM 1110, including operating system 1132, one or more application programs 1134, other program modules 1136, and program data 1138. In some examples, the application programs 1134 can include one or more modules (or block diagrams), or systems, as shown and disclosed herein.

A user may enter commands and information into computer system 1100 through one or more input devices 1140, such as a pointing device (e.g., a mouse, touch screen), keyboard, microphone, joystick, game pad, scanner, and the like. These and other input devices are often connected to processing unit 1102 through a corresponding port interface 1142 that is coupled to the system bus, but may be connected by other interfaces, such as a parallel port, serial port, or universal serial bus (USB). One or more output devices 1144 (e.g., display, a monitor, printer, projector, or other type of displaying device) is also connected to system bus 1106 via interface 1146, such as a video adapter.

Computer system 1100 may operate in a networked environment using logical connections to one or more remote computers, such as remote computer 1148. Remote computer 1148 may be a workstation, computer system, router, peer device, or other common network node, and typically includes many or all the elements described relative to computer system 1100. The logical connections, schematically indicated at 1150, can include a local area network (LAN) and a wide area network (WAN). When used in a LAN networking environment, computer system 1100 can be connected to the local network through a network interface or adapter 1152. When used in a WAN networking environment, computer system 1100 can include a modem, or can be connected to a communications server on the LAN. The modem, which may be internal or external, can be connected to system bus 1106 via an appropriate port interface. In a networked environment, application programs 1134 or program data 1138 depicted relative to computer system 1100, or portions thereof, may be stored in a remote memory storage device 1154.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

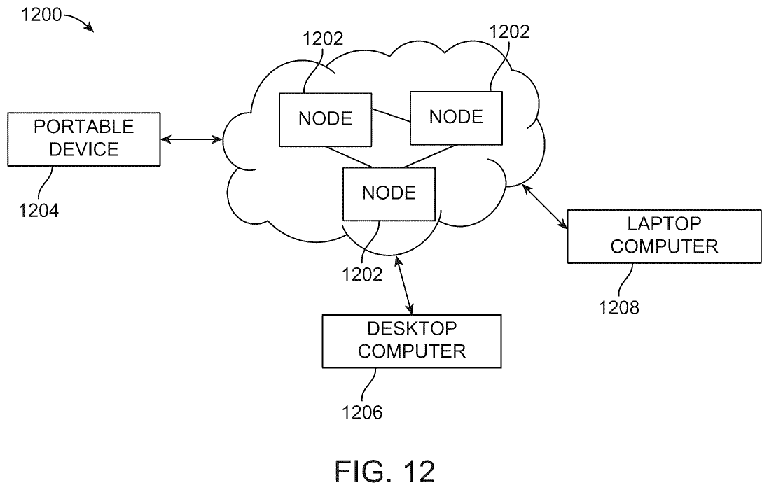

FIG. 12 is an example of a cloud computing environment 1200 that can be used for implementing one or more modules and/or systems in accordance with one or more examples, as disclosed herein. Thus, reference can be made to one or more examples of FIGS. 1-6 in the example of FIG. 12. As shown, cloud computing environment 1200 can include one or more cloud computing nodes 1202 with which local computing devices used by cloud consumers (or users), such as, for example, personal digital assistant (PDA), cellular, or portable device 1204, a desktop computer 1206, and/or a laptop computer 1208, may communicate. The computing nodes 1202 can communicate with one another. In some examples, the computing nodes 1202 can be grouped (not shown) physically or virtually, in one or more networks, such as Private, Community, Public, or Hybrid clouds, or a combination thereof. This allows the cloud computing environment 1200 to offer infrastructure, platforms and/or software as services for which a cloud consumer does not need to maintain resources on a local computing device. The devices 1204-1208, as shown in FIG. 12, are intended to be illustrative and that computing nodes 1202 and cloud computing environment 1200 can communicate with any type of computerized device over any type of network and/or network addressable connection (e.g., using a web browser). In some examples, the one or more computing nodes 1202 are used for implementing one or more examples disclosed herein. Thus, in some examples, the one or more computing nodes can be used to implement modules, platforms, and/or systems, as disclosed herein.

In some examples, the cloud computing environment 1200 can provide one or more functional abstraction layers. It is to be understood that the cloud computing environment 1200 need not provide all of the one or more functional abstraction layers (and corresponding functions and/or components), as disclosed herein. For example, the cloud computing environment 1200 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 1200 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 1200 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 1200, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 1200 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 1200 can provide a workloads layer that provides examples of functionality for which the cloud computing environment 1200 may be utilized. Examples of workloads and functions which may be provided from this layer include: mapping and navigation; software development and lifecycle management; virtual classroom education delivery; data analytics processing; and transaction processing. Various embodiments of the present disclosure can utilize the cloud computing environment 1200.

The present disclosure is also directed to the following exemplary embodiments, which can be practiced in any combination thereof:

Embodiment A: a system for monitoring equipment for anomaly event comprising: an edge monitoring node comprising: a thermal camera to capture a thermal image of the equipment; an ML model to process the thermal image of the equipment and an additional thermal image of the equipment from another thermal camera that is remote to the edge monitoring node to detect the anomaly event; and a network interface to communicate the detected anomaly event over a network to a remote computing platform to determine one or more recommendations for proactive maintenance of the equipment.

Embodiment B: a method for detecting an anomaly event of equipment using an edge monitoring node comprising: receiving, using the edge monitoring node, a first thermal image captured of the equipment at a first viewpoint with respect to the equipment; receiving, using the edge monitoring node, a second thermal image captured of the equipment at a second viewpoint with respect to the equipment; combining, using the edge monitoring node, the first and second thermal images provide a combined thermal image; processing, using the edge monitoring node, the combined thermal image using an ML model to detect the anomaly event; and communicating, using the edge monitoring node, the detected anomaly event to a remote computing platform to initiate maintenance of the equipment.

Embodiment C: a system comprising: a first edge monitoring node comprising a first thermal camera to provide a first thermal image of equipment a first angle relative to the equipment; a second edge monitoring node comprising: a second thermal camera to provide a second thermal image of the equipment at a second angle relative to the equipment; an anomaly detection model to process the first and second thermal images to detect an anomaly event at the equipment; a network interface to communicate the detected anomaly event over a network; a remote computing platform to receive the communicated detected anomaly event from the network and comprising: a recommendation engine to determine one or more recommendations for proactive maintenance of the equipment; a report generator to generate an anomaly report comprising the one or more determined recommendations, and wherein the remote computing platform is implemented one or more computing nodes in a cloud computing environment, and the second edge monitoring node is implemented at an edge of the network.

Each of embodiment's A through C may have one or more of the following additional elements in any combination: Embodiment 1: wherein the remote computing platform is implemented one or more computing nodes in a cloud computing environment, and the edge monitoring node is implemented at an edge of the network; Embodiment 2: wherein the edge monitoring node comprises an equipment controller to generate a control command for the equipment, the control command being communicated by the network interface over the network to the equipment to adjust an operating state of the equipment; Element 4: wherein the ML model is to provide anomaly data that comprises an identification of the anomaly event, a location of the anomaly event on the equipment, a severity of the anomaly event, a timestamp when the anomaly event was detected, a historical reference, and/or an environmental condition information; Element 5: wherein communication of the detected anomaly event to the computing platform causes a recommendation engine to determine the one or more recommendations and identify a respective recommendation of the one or more recommendations for the proactive maintenance of the equipment; Element 6: wherein the computing platform comprises a report generator to generate an anomaly report based on the respective recommendation; Element 7: wherein an ML model is trained using training data comprising containing healthy and defective thermal images of the equipment from a number of different viewpoints of the equipment to provide the trained ML model; Element 8: wherein the edge monitoring node is a first edge monitoring node, the thermal camera is a first thermal camera, the thermal image is a first thermal image, the additional thermal image is a second thermal image, the another thermal camera is a second thermal camera, and the network interface is a first network interface, wherein the first thermal camera provides the first thermal image of the equipment at a first viewpoint with respect to the equipment; the system further comprising a second edge monitoring node comprising: the second thermal camera to provide the second thermal image of the equipment at a second viewpoint with respect to the equipment; and a second network interface to provide the second thermal image of the equipment to the first edge monitoring node; Element 9: wherein the ML model processes the first, second, and third thermal images of the equipment to detect the anomaly, the third thermal image being provided by a third thermal camera of a third edge monitoring node; Element 10: wherein the edge monitoring node comprises a housing with a mechanical attachment for attaching the edge monitoring node to a structure for monitoring the equipment; Element 11: wherein the edge monitoring node comprises an SD card that is used to store the thermal image; Element 12: wherein the combining, using the edge monitoring node, comprises: segmenting, using the edge monitoring node, the first thermal image to provide a first segmented thermal image; segmenting, using the edge monitoring node, the second thermal image to provide a second segmented thermal image; and concatenating, using the edge monitoring node, the first and second segmented thermal images to provide a concatenated thermal image corresponding to the combined thermal image; Element 13: wherein the processing, using the edge monitoring node, comprises applying a classification technique to determine a type of anomaly event at the equipment; Element 14: wherein the processing, using the edge monitoring node, comprises applying regression technique to determine a severity of the anomaly event; Element 15: wherein the processing, using the edge monitoring node, comprises applying a feature map technique to identify hot and/or cold spots on the equipment; Element 16: wherein the processing, using the edge monitoring node, comprises applying a change detection technique to detect the anomaly event; Element 17: further comprising: generating, using the edge monitoring node, a control command for the equipment; and communicating, using the edge monitoring node, the control command over a network to the equipment over the network to adjust an operating state of the equipment to reduce a risk of damage to the equipment or loss of human life; and Element 18: wherein the processing, using the edge monitoring node, comprises: generating, using the edge monitoring node, a heatmap identifying one or more regions of interest in the thermal image corresponding to one or more pixels of the the thermal image that had a greatest influence on a final output of the ML model; upscaling, using the edge monitoring node, the heatmap to match a dimensionality of the thermal image; and overlaying, using the edge monitoring node, the upsampled heatmap over the thermal image to provide an anomaly localization map to highlight where on the equipment the anomaly event is located corresponding to the one or more regions of interest.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 5-10% of the indicated number.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

The invention claimed is:

1. A system for monitoring equipment for anomaly event comprising:
an edge monitoring node comprising:
a thermal camera to capture a thermal image of the equipment;
a machine learning (ML) model to process the thermal image of the equipment and an additional thermal image of the equipment from another thermal camera that is remote to the edge monitoring node to detect the anomaly event; and
a network interface to communicate the detected anomaly event over a network to a remote computing platform to determine one or more recommendations for proactive maintenance of the equipment.

2. The system of claim 1, wherein the remote computing platform is implemented on one or more computing nodes in a cloud computing environment, and the edge monitoring node is implemented at an edge of the network.

3. The system of claim 1, wherein the edge monitoring node comprises an equipment controller to generate a control command for the equipment, the control command being communicated by the network interface over the network to the equipment to adjust an operating state of the equipment.

4. The system of claim 1, wherein the ML model is to provide anomaly data that comprises an identification of the anomaly event, a location of the anomaly event on the equipment, a severity of the anomaly event, a timestamp when the anomaly event was detected, a historical reference, and/or an environmental condition information.

5. The system of claim 1, wherein communication of the detected anomaly event to the computing platform causes a recommendation engine to determine the one or more recommendations and identify a respective recommendation of the one or more recommendations for the proactive maintenance of the equipment.

6. The system of claim 5, wherein the computing platform comprises a report generator to generate an anomaly report based on the respective recommendation.

7. The system of claim 1, wherein an ML model is trained using training data comprising containing healthy and defective thermal images of the equipment from a number of different viewpoints of the equipment to provide the trained ML model.

8. The system of claim 1,
wherein the edge monitoring node is a first edge monitoring node, the thermal camera is a first thermal camera, the thermal image is a first thermal image, the additional thermal image is a second thermal image, the another thermal camera is a second thermal camera, and the network interface is a first network interface,
wherein the first thermal camera provides the first thermal image of the equipment at a first viewpoint with respect to the equipment;
the system further comprising a second edge monitoring node comprising:
the second thermal camera to provide the second thermal image of the equipment at a second viewpoint with respect to the equipment; and
a second network interface to provide the second thermal image of the equipment to the first edge monitoring node.

9. The system of claim 7, wherein the ML model processes the first, second, and third thermal images of the equipment to detect the anomaly, the third thermal image being provided by a third thermal camera of a third edge monitoring node.

10. The system of claim 1, wherein the edge monitoring node comprises a housing with a mechanical attachment for attaching the edge monitoring node to a structure for monitoring the equipment.

11. The system of claim 1, wherein the edge monitoring node comprises a secure digital (SD) card that is used to store the thermal image.

12. A method for detecting an anomaly event of equipment using an edge monitoring node comprising:
receiving, using the edge monitoring node, a first thermal image captured of the equipment at a first viewpoint with respect to the equipment;
receiving, using the edge monitoring node, a second thermal image captured of the equipment at a second viewpoint with respect to the equipment;
combining, using the edge monitoring node, the first and second thermal images provide a combined thermal image;
processing, using the edge monitoring node, the combined thermal image using a machine learning (ML) model to detect the anomaly event; and
communicating, using the edge monitoring node, the detected anomaly event to a remote computing platform to initiate maintenance of the equipment.

13. The method of claim 12, wherein the combining, using the edge monitoring node, comprises:
segmenting, using the edge monitoring node, the first thermal image to provide a first segmented thermal image;
segmenting, using the edge monitoring node, the second thermal image to provide a second segmented thermal image; and
concatenating, using the edge monitoring node, the first and second segmented thermal images to provide a concatenated thermal image corresponding to the combined thermal image.

14. The method of claim 12, wherein the processing, using the edge monitoring node, comprises applying a classification technique to determine a type of anomaly event at the equipment.

15. The method of claim 12, wherein the processing, using the edge monitoring node, comprises applying regression technique to determine a severity of the anomaly event.

16. The method of claim 12, wherein the processing, using the edge monitoring node, comprises applying a feature map technique to identify hot and/or cold spots on the equipment.

17. The method of claim 12, wherein the processing, using the edge monitoring node, comprises applying a change detection technique to detect the anomaly event.

18. The method of claim 12, further comprising:
generating, using the edge monitoring node, a control command for the equipment; and
communicating, using the edge monitoring node, the control command over a network to the equipment over the network to adjust an operating state of the equipment to reduce a risk of damage to the equipment or loss of human life.

19. The method of claim 12, wherein the processing, using the edge monitoring node, comprises:
generating, using the edge monitoring node, a heatmap identifying one or more regions of interest in the thermal image corresponding to one or more pixels of the the thermal image that had a greatest influence on a final output of the ML model;
upscaling, using the edge monitoring node, the heatmap to match a dimensionality of the thermal image; and
overlaying, using the edge monitoring node, the upsampled heatmap over the thermal image to provide an anomaly localization map to highlight where on the equipment the anomaly event is located corresponding to the one or more regions of interest.

20. A system comprising:
a first edge monitoring node comprising a first thermal camera to provide a first thermal image of equipment a first angle relative to the equipment;
a second edge monitoring node comprising:
a second thermal camera to provide a second thermal image of the equipment at a second angle relative to the equipment;
an anomaly detection model to process the first and second thermal images to detect an anomaly event at the equipment;
a network interface to communicate the detected anomaly event over a network;
a remote computing platform to receive the communicated detected anomaly event from the network and comprising:
a recommendation engine to determine one or more recommendations for proactive maintenance of the equipment;
a report generator to generate an anomaly report comprising the one or more determined recommendations, and
wherein the remote computing platform is implemented on one or more computing nodes in a cloud computing environment, and the second edge monitoring node is implemented at an edge of the network.
